(19) United States
(12) Patent Application Publication
(10) Pub. No.: US 2004/0097154 A1
(43) Pub. Date: May 20, 2004

(54) Multi-layer mechanically needed spunbond fabric and process for making

(76) Inventor: Vishal Bansal, Richmodn, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/299,370

(22) Filed: Nov. 19, 2002

(51) Int. Cl. D04H 3/00

(52) U.S. Cl. 442/345; 442/383

(57) ABSTRACT

A stretchable composite nonwoven web is provided which is formed by mechanically needling a crimped multiple component spunbond web to an elastomeric spunbond web. The composite nonwoven has improved softness and stretch properties with good surface stability compared to similar materials that are thermally bonded.

### BACKGROUND OF THE INVENTION

1. Field of the Invention

This invention relates to multi-layer composite nonwoven sheets that are stretchable, bulky, and have a soft textile hand. More specifically, the invention relates to multi-layer spunbond fabrics which comprise a spunbond layer of crimped multiple component filaments mechanically needled to an elastomeric spunbond layer.

2. Description of the Related Art

Elastomeric spunbond nonwoven fabrics are known in the art. For example, U.S. Pat. No. 5,997,989 to Gessner et al. (Gessner) describes a method for preparing bonded spunbond elastomeric fabrics using a slot draw process operated at a rate of less than about 2000 m/min. However, these materials have an undesirable rubber-like hand, characteristic of the elastomeric polymers from which they are prepared.

Composite nonwoven fabrics comprising an elastic layer and a nonelastic layer are also known in the art. For example, U.S. Pat. No. 5,540,976 to Schawyer et al. (Schawyer) describes nonwoven laminates comprised of at least 3 layers in which the outer layers are spunbond nonwoven fiber webs made of crimped or crimpable fibers and the inner layer is an elastomeric polymer layer, such as an elastomeric meltblown web. The layers are bonded by methods (excluding hydroentanglement), such as thermal point bonding, through-air bonding, or ultrasonic bonding.

Bulky elastic composite nonwoven materials are also known in the art. Examples of such materials include “stretch-bonded” and “neck-bonded” laminates. Stretch-bonded laminates are prepared by joining a gatherable layer to an elastic layer while the elastic layer is in an extended condition so that upon relaxing the layers, the gatherable layer is gathered. “Neck-bonded laminates” are produced by joining a necked, non-elastic layer with an elastic layer when the non-elastic layer is in an extended condition. The elastic layer in these products generally comprises an elastic film or an elastic nonwoven web such as an elastic meltblown web. For example, U.S. Pat. No. 5,635,290 to Stopper et al. (Stopper) describes multi-layer composites containing at least one layer of a multiple component fiber web and one layer of an elastomeric material, wherein the nonwoven web layer is joined to the elastic layer at spaced-apart locations and is gathered between the spaced-apart locations.

Mechanically needled spunbond materials are also known in the art. For example, U.S. Pat. No. 5,213,735 to Schneider et al. (Schneider) describes a method for manufacturing needled spunbonds wherein, prior to needling, the as-spun web is thermally sealed at the surfaces and provided with a lubricant.

There remains a need for low-cost stretchable nonwoven fabrics that are soft and bulky, as well as durable.

### BRIEF SUMMARY OF THE INVENTION

This invention is a stretchable multi-layer composite nonwoven sheet having first and second outer surfaces and comprising a crimped multiple component continuous filament spunbond layer mechanically needled to a continuous filament elastomeric spunbond layer and a process for making the composite nonwoven sheet.

### DETAILED DESCRIPTION OF THE INVENTION

The current invention provides a stretchable multi-layer composite nonwoven sheet that comprises at least one elastomeric spunbond layer mechanically needled to at least one crimped multiple component spunbond layer. The multi-layer composite sheets of the current invention have an improved balance of stretchability, softness, bulk, and surface stability compared to conventional composite nonwoven materials. By using mechanical needling to bond the layers of the composite material together, much of the bulk of the original crimped multiple component spunbond layer is retained in the final composite sheet. Mechanical needling also allows the layers to be bonded to a sufficient degree to obtain a composite material that is durable, yet soft and which also retains a substantial degree of stretch.

Other bonding methods known in the art do not provide the balance of properties achieved in the current invention. For example, in thermal bonding, relatively low levels of bonding must be used to retain the recoverable stretch properties of the composite nonwoven sheet and to avoid forming a nonwoven composite material having a surface with a harsh hand. At the lower levels of thermal bonding used to achieve composite nonwoven sheets having recoverable stretch and a relatively soft hand, the surface stability of the composite sheet is not sufficient for certain end uses. Further, certain thermal bonding methods, for example bonding of a composite nonwoven sheet in the nip formed by two calender rolls also can consolidate the nonwoven layers in a way that-reduces the thickness and bulk of the composite nonwoven sheet. When hydroentangling methods are used to bond the composite structures, softness is generally retained but the bulk of the composite is usually substantially reduced. Hydraulic needling (hydroentangling) has the further disadvantage of being limited to processes utilizing relatively low basis weight nonwoven substrates.

The term “polyolefin” as used herein, is intended to mean any of a series of largely saturated open chain polymeric hydrocarbons composed only of carbon and hydrogen. Typical polyolefins include, but are not limited to, polyethylene, polypropylene, polymethylpentene and various combinations of the ethylene, propylene, and methylpentene monomers.

The term “polyethylene” as used herein is intended to encompass not only homopolymers of ethylene, but also copolymers wherein at least 85% of the recurring units are ethylene units.

The term “linear low density polyethylene” (LLDPE) as used herein refers to linear ethylene/α-olefin co-polymers having a density of less than about 0.955 g/cm³, preferably in the range of 0.91 g/cm³ to 0.95 g/cm³, and more preferably in the range of 0.92 g/cm³ to 0.95 g/cm³. Linear low density polyethylenes suitable for use in the current invention are prepared by co-polymerizing ethylene with minor amounts of an alpha,beta-ethylenically unsaturated alkene co-monomer (α-olefin), the α-olefin co-monomer having from 3 to 12 carbons per α-olefin molecule, and preferably from 4 to 8 carbons per α-olefin molecule. Alpha-olefins which can be co-polymerized with ethylene to produce LLDPE's useful in the present invention include propylene, 1-butene, 1-pentene, 1-hexene, 1-octene, 1-decene, or a mixture thereof. Preferably, the α-olefin is 1-hexene or 1-octene.

The term “high density polyethylene” (HDPE) as used herein refers to polyethylene homopolymer having a density of at least about 0.94 g/cm³, and preferably in the range of about 0.94 g/cm³ to about 0.965 g/cm³.

The term “polypropylene” as used herein is intended to embrace not only homopolymers of propylene but also copolymers where at least 85% of the recurring units are propylene units.

The term “polyester” as used herein is intended to embrace polymers wherein at least 85% of the recurring units are condensation products of dicarboxylic acids and dihydroxy alcohols with linkages created by formation of ester units. This includes aromatic, aliphatic, saturated, and unsaturated di-acids and di-alcohols. The term “polyester” as used herein also includes copolymers (such as block, graft, random and alternating copolymers), blends, and modifications thereof. A common example of a polyester is poly(ethylene terephthalate) (PET) which is a condensation product of ethylene glycol and terephthalic acid.

By “elastomeric polymer” is meant a polymer which in monocomponent fiber form, free of diluents, has a break elongation in excess of 100% and which when stretched to twice its length, held for five seconds, and then released, retracts to less than 1.5 times its original length within one minute of being released.

The term “recover” as used herein refers to a retraction of a stretched material upon termination of a biasing force following stretching of the material by application of the biasing force. For example, if a material having an initial, unbiased length of 1.0 centimeter (cm) is elongated 60 percent by stretching to a length of 1.6 centimeters, the material would be elongated 60% (0.6 cm) and would have a stretched length that is 160 percent of its initial length. If this stretched material is allowed to contract upon removal of the biasing and stretching force, that is, to recover to a length of 1.2 centimeters, the material would have recovered about 67% (0:4 cm) of its 0.6 cm elongation.

The term “cyclic recoverable stretch” refers to the maximum amount of stretch that a material can achieve and maintain substantially 100% recovery after a number of cycles of stretch and recovery.

The terms “nonwoven fabric, sheet, layer or web” as used herein mean a structure of individual fibers that are positioned in a random manner to form a planar material without an identifiable pattern, as opposed to a knitted or woven fabric.

The term “multi-layer composite nonwoven sheet” is used herein to refer to a construction comprising at least two nonwoven layers. The multi-layer composite nonwoven sheets of the current invention comprise at least one crimped multiple component spunbond layer and at least one elastomeric spunbond layer.

The term “spunbond” filaments as used herein means filaments which are formed by extruding molten thermoplastic polymer material as filaments from a plurality of fine capillaries of a spinneret with the diameter of the extruded filaments then being rapidly reduced by drawing and quenching the filaments. Spunbond filaments are substantially continuous and usually have an average diameter of greater than about 5 micrometers. Spunbond nonwoven fabrics or webs are formed by laying spunbond filaments randomly on a collecting surface such as a screen or belt.

The term “multiple component filament” as used herein refers to any filament that is composed of at least two distinct polymeric components which have been spun together to form a single filament. The at least two distinct polymers can be spun from the same capillary (i.e., the pre-coalescent method). Also, the polymers can be spun from separate capillaries and joined to form a single filament after extrusion from the spinneret (i.e., the post-coalescent method). Each of the at least two distinct polymeric components are arranged in distinct substantially constantly positioned zones across the cross-section of the multiple component filaments, with the zones of distinct polymers extending substantially continuously along the length of the filaments. Crimped multiple component filaments used to form the crimped spunbond layer of the composite nonwoven sheets of the current invention have laterally eccentric cross-sections. By the term “laterally eccentric”, it is meant that the polymeric components are arranged in an eccentric relationship in the cross-section of the filament. Preferably, the crimped multiple component filaments are bicomponent filaments which are made of two distinct polymers having an eccentric sheath-core or a side-by-side arrangement of the polymers. Multiple component filaments are distinguished from filaments formed from two or more polymers that are blended together prior to extrusion, however one or more of the polymeric components in a multiple component filament can comprise a polymer blend. The term “multiple component web” as used herein refers to a nonwoven web comprising multiple component filaments. The term “bicomponent web” as used herein refers to a nonwoven web comprising bicomponent filaments. Multiple component spunbond nonwoven webs comprising laterally eccentric multiple component filaments comprising two or more synthetic components which differ in their ability to shrink are known in the art. Such filaments form three-dimensional crimp when the crimp is activated, for example by heating the filaments to a sufficient temperature to cause the crimp to be developed. The crimp level in the crimped spunbond layer should be at a level sufficient to achieve the desired properties in the final composite.

When the multiple component filaments are spun in a side-by-side conformation, the crimped filaments that are formed after crimp activation have regions of spiral crimp with the higher-shrinkage polymeric component on the inside of the spiral helix and the lower-shrinkage polymeric component on the outside of the helix.

A variety of thermoplastic polymers may be used to form the components of multiple component filaments that are capable of developing three-dimensional crimp. Examples of combinations of such thermoplastic resins suitable for forming spirally crimpable, multiple component filaments are crystalline polypropylene/high density polyethylene, crystalline polypropylene/ethylene-vinyl acetate copolymers, poly(ethylene terephthalate)/high density polyethylene, poly(ethylene terephthalate)/linear low density polyethylene, poly(ethylene terephthalate)/poly(trimethylene terephthalate), poly(ethylene terephthalate)/poly(butylene terephthalate), and nylon 66/nylon 6.

To achieve high levels of three dimensional spiral crimp in the crimped spunbond layer, the polymeric components of the multiple component filaments can be selected according to the teaching in U.S. Pat. No. 3,671,379 to Evans, et al. (Evans), which is hereby incorporated by reference. The Evans patent describes bicomponent filaments in which the polymeric components are partly crystalline polyesters, the first of which has chemical repeat-units in its crystalline region that are in a non-extended stable conformation that does not exceed 90 percent of the length of the conformation of its fully extended chemical repeat units. The second of which has chemical repeat-units in its crystalline region which are in a conformation more closely approaching the length of the conformation of its fully extended chemical repeat-units than the first polyester. The term “partly crystalline” as used in defining the filaments of Evans serves to eliminate from the scope of the invention the limiting situation of complete crystallinity where the potential for shrinkage would disappear. The amount of crystallinity, defined by the term “partly crystalline” has a minimum level of only the presence of some crystallinity (i.e. that which is first detectable by X-ray diffraction means) and a maximum level of any amount short of complete crystallinity.

Examples of suitable fully extended polyesters are poly(ethylene terephthalate), poly(cyclohexyl 1,4-dimethylene terephthalate), copolymers thereof, and copolymers of ethylene terephthalate and the sodium salt of ethylene sulfoisophthalate.

Examples of suitable non-extended polyesters are poly(trimethylene terephthalate), poly(tetramethylene terephthalate), poly(trimethylene dinaphthalate), poly(trimethylene bibenzoate), and copolymers of the above with ethylene sodium sulfoisophthalate, and selected polyester ethers. When ethylene sodium sulfoisophthalate copolymers are used, it is preferably the minor component, i.e. present in amounts of less than 5 mole percent and preferably present in amounts of about 2 mole percent. In an especially preferred embodiment, the two polyesters are poly(ethylene terephthalate) and poly(trimethylene terephthalate).

The bicomponent filaments of Evans have a high degree of three-dimensional spiral crimp, generally acting as springs, having a recoil action whenever a stretching force is applied and released. Other partly crystalline polymers which are suitable for use in preparing the crimped spunbond layer include syndiotactic polypropylene which crystallizes in an extended conformation and isotactic polypropylene which crystallizes in a non-extended, helical conformation.

Elastomeric polymers suitable for forming elastomeric spunbond webs useful in preparing the composite nonwoven materials of the current invention may be any fiber-forming thermoplastic elastomeric polymer composition. Examples of suitable elastomers include thermoplastic polyurethane, polyester, polyolefin, and polyamide elastomers. A blend of two or more elastomeric polymers or a blend of at least one elastomeric polymer with one or more hard polymers may be used. If a blend of an elastomeric polymer with a hard polymer is used, the hard polymer should be added at sufficiently low amounts that the polymer blend retains elastomeric properties as defined above. The elastomeric spunbond material can comprise single component spunbond filaments consisting essentially of a thermoplastic elastomeric polymer composition. Alternately, the elastomeric spunbond nonwoven web can comprise multiple component elastomeric filaments which comprise an elastomeric polymeric core and polymeric wings attached to the core wherein the polymeric wing is either non-elastomeric or is less elastic than the core polymer and the polymeric wings are arranged in a spiral twist configuration about the elastomeric core. The term “spiral twist” is used herein to refer to twist in which a fiber is twisted around its longitudinal axis. Spunbond nonwovens made from elastomeric spirally twisted multiple component filaments are described in pending U.S. Provisional Patent Application No. 60/325,624, which is hereby incorporated by reference.

Useful thermoplastic polyurethane elastomers include those prepared from a polymeric glycol, a diisocyanate, and at least one diol or diamine chain extender. Diol chain extenders are preferred because the polyurethanes made therewith have lower melting points than if a diamine chain extender were used. Polymeric glycols useful in the preparation of the elastomeric polyurethanes include polyether glycols, polyester glycols, polycarbonate glycols and copolymers thereof. Examples of such glycols include poly(ethyleneether)glycol, poly(tetramethyleneether)glycol, poly(tetramethylene-co-2-methyl-tetramethyleneether)glycol, poly(ethylene-co-1,4-butylene adipate)glycol, poly(ethylene-co-1,2-propylene adipate)glycol, poly(hexamethylene-co-2,2-dimethyl-1,3-propylene adipate), poly(3-methyl-1,5-pentylene adipate)glycol, poly(3-methyl-1,5-pentylene nonanoate)glycol, poly(2,2-dimethyl-1,3-propylene dodecanoate)glycol, poly(pentane-1,5-carbonate)glycol, and poly(hexane-1,6-carbonate)glycol. Useful diisocyanates include 1-isocyanato-4-[(4-isocyanatophenyl)methyl]benzene, 1-isocyanato-2-[(4-isocyanato-phenyl)methyl]benzene, isophorone diisocyanate, 1,6-hexanediisocyanate, 2,2-bis(4-isocyanatophenyl)propane, 1,4-bis(p-isocyanato,alpha,alpha-dimethylbenzyl)benzene, 1,1′-methylenebis(4-isocyanatocyclohexane), and 2,4-tolylene diisocyanate. Useful diol chain extenders include ethylene glycol, 1,3-trimethylene glycol, 1,4-butanediol, 2,2-dimethyl-1,3-propylene diol, diethylene glycol, and mixtures thereof. Preferred polymeric glycols are poly(tetramethyleneether)glycol, poly(tetramethylene-co-2-methyl-tetramethyleneether)glycol, poly(ethylene-co-1,4-butylene adipate)glycol, and poly(2,2-dimethyl-1,3-propylene dodecanoate)glycol. 1-Isocyanato-4-[(4-isocyanatophenyl)methyl]benzene is a preferred diisocyanate. Preferred diol chain extenders are 1,3-trimethylene glycol and 1,4-butanediol. Monofunctional chain terminators such as 1-butanol and the like can be added to control the molecular weight of the polymer. Suitable polyurethane elastomers include Pellethane® thermoplastic polyurethanes available from Dow Chemical Company.

Suitable thermoplastic polyester elastomers include the polyetheresters made by the reaction of a polyether glycol with a low-molecular weight diol, for example, a molecular weight of less than about 250, and a dicarboxylic acid or diester thereof. Useful polyether glycols include poly(ethyleneether)glycol, poly(tetramethyleneether)glycol, poly(tetramethylene-co-2-methyltetramethyleneether)glycol [derived from the copolymerization of tetrahydrofuran and 3-methyltetrahydrofuran] and poly(ethylene-co-tetramethyleneether)glycol. Useful low-molecular weight diols include ethylene glycol, 1,3-trimethylene glycol, 1,4-butanediol, 2,2-dimethyl-1,3-propylene diol, and mixtures thereof; 1,3-trimethylene glycol and 1,4-butanediol are preferred. Useful dicarboxylic acids include terephthalic acid, optionally with minor amounts of isophthalic acid, and diesters thereof (e.g., <20 mol %). Examples of commercially available polyester elastomers include Hytrel® polyetheresters available from E. I. du Pont de Nemours and Company, Wilmington, Del. (DuPont).

Suitable thermoplastic polyesteramide elastomers include those described in U.S. Pat. No. 3,468,975, herein incorporated by reference. For example, such elastomers can be prepared with polyester segments made by the reaction of ethylene glycol, 1,2-propanediol, 1,3-propanediol, 1,4-butanediol, 2,2-dimethyl-1,3-propanediol, 1,5-pentanediol, 1,6-hexanediol, 1,10-decandiol, 1,4-di(methylol)cyclohexane, diethylene glycol, or triethylene glycol with malonic acid, succinic acid, glutaric acid, adipic acid, 2-methyladipic acid, 3-methyladipic acid, 3,4-dimethyladipic acid, pimelic acid, suberic acid, azelaic acid, sebacic acid, or dodecandioic acid, or esters thereof. Examples of polyamide segments in such polyesteramides include those prepared by the reaction of hexamethylene diamine or dodecamethylene diamine with terephthalic acid, oxalic acid, adipic acid, or sebacic acid, and by the ring-opening polymerization of caprolactam.

Thermoplastic polyetheresteramide elastomers, such as those described in U.S. Pat. No. 4,230,838, herein incorporated by reference, can also be used to make the elastomeric spunbond layer. Such elastomers can be prepared, for example, by preparing a dicarboxylic acid-terminated polyamide prepolymer from a low molecular weight (for example, about 300 to about 15,000) polycaprolactam, polyoenantholactam, polydodecanolactam, polyundecanolactam, poly(11-aminoundecanoic acid), poly(12-aminododecanoic acid), poly(hexamethylene adipate), poly(hexamethylene azelate), poly(hexamethylene sebacate), poly(hexamethylene undecanoate), poly(hexamethylene dodecanoate), poly(nonamethylene adipate), or the like and succinic acid, adipic acid, suberic acid, azelaic acid, sebacic acid, undecanedioic acid, terephthalic acid, dodecanedioic acid, or the like. The prepolymer can then be reacted with an hydroxy-terminated polyether, for example poly(tetramethylene ether)glycol, poly(tetramethylene-co-2-methyltetramethylene ether)glycol, poly(propylene ether)glycol, poly(ethylene ether)glycol, or the like. Examples of commercially available polyetheresteramide elastomers include Pebax® polyetheresteramides, available from Atofina, Philadelphia, Pa.

Examples of suitable polyolefin elastomers include polypropylene-based copolymers or terpolymers and polyethylene-based copolymers or terpolymers. A preferred class of elastomeric polyolefins is copolymers of ethylene/1-octene available commercially as Engage® polymers from Dow Chemical Company. Engage® polymers generally contain about 15 to about 25 mole percent 1-octene. Other olefin-based elastomers include those commercially available as the Exact® resins from ExxonMobil and the Affinity® resins from Dow Chemical Company, having densities less than about 0.91 g/cm³. These are all co-polymers of ethylene with 1-octene, 1-hexene, or 1-butene, made with single-site catalysts, and are generally referred to as plastomers. Elastic properties generally increase and density generally decreases as the alpha-olefin co-monomer level is increased. Affinity® plastomers available from Dow Chemical Company contain about 3 to about 15 mole percent 1-octene. Elastomeric polyolefins including elastomeric polypropylenes may be formed according to the method described in U.S. Pat. No. 6,143,842 to Paton et al. (Paton) which is hereby incorporated by reference. Other suitable polyolefin elastomers include ethylene/propylene hydrocarbon rubbers with and without diene cross-linking, such as Nordel® elastomers, available from DuPont Dow Elastomers (Wilmington, Del.).

Elastomeric polyolefins disclosed in EPO Publication 0416379 published Mar. 13, 1991, which is hereby incorporated by reference, may also be used to form the elastomeric spunbond layer. These polymers are heterophasic block copolymers which include a crystalline base polymer fraction and an amorphous copolymer fraction having elastic properties which is blocked thereon via semi-crystalline homopolymer or copolymer fraction. In a preferred embodiment, the thermoplastic primarily crystalline olefin polymer is comprised of at least about 60 to 85 parts of the crystalline polymer fraction, at least about 1 up to less than 15 parts of the semi-crystalline polymer fraction and at least about 10 to less than 39 parts of the amorphous polymer fraction. More preferably, the primarily crystalline olefin block copolymer comprises 65 to 75 parts of the crystalline copolymer fraction, from 3 to less than 15 parts of the semi-crystalline polymer fraction, and from 10 to less than 30 parts of the amorphous copolymer fraction.

Other suitable polyolefin elastomers include those in which the crystalline base polymer block of the heterophasic copolymer is a copolymer of propylene and at least one alpha-olefin having the formula H₂C═CHR, where R is H or a C₂₋₆ straight or branched chain alkyl moiety. Preferably, the amorphous copolymer block with elastic properties of the heterophasic copolymer comprises an alpha-olefin and propylene with or without a diene or a different alpha-olefin terpolymer. The semi-crystalline copolymer block is a low density, essentially linear copolymer consisting substantially of units of the alpha-olefin used to prepare the amorphous block or the alpha-olefin used to prepare the amorphous block present in the greatest amount when two alpha-olefins are used.

High pressure ethylene copolymers can also be used to form the elastomeric spunbond layer. Examples include ethylene vinyl acetate copolymers (e.g. ELVAX® polymers available from DuPont), ethylene methyl acrylate copolymers (e.g. Optema® polymers available from ExxonMobil), ethylene-methyl acrylate-acrylic acid terpolymers (e.g. Escor® polymers also available from ExxonMobil), and ethylene acrylic acid and ethylene methacrylic acid copolymers (e.g. Nucrel® polymers available from DuPont).

Other thermoplastic elastomers suitable for use in preparing the elastomeric spunbond layer include styrenic block copolymers having the general formula A-B-A′ or A-B, where A and A′ are each a polymer end block which contains a styrenic moiety such as a poly(vinyl arene) and B is an elastomeric polymer midblock such as a conjugated diene or a lower alkene polymer. Block copolymers of the A-B-A′ type can have either different or the same block polymers for the A and A′ blocks. Examples of such block copolymers include copoly(styrene/ethylene-butylene), styrene-poly(ethylene-propylene)-styrene, styrene-poly(ethylene-butylene)-styrene, poly(styrene/ethylene-butylene/styrene) and the like. Commercial examples of such block copolymers are Kraton® block copolymers which are available from Kraton Polymers (formerly available from Shell Chemical Company of Houston, Tex.). Examples of such block copolymers are described in U.S. Pat. No. 4,663,220 and U.S. Pat. No. 5,304,599, hereby incorporated by reference.

Polymers composed of an elastomeric A-B-A-B tetrablock copolymer may also be used to prepare the elastomeric spunbond layer. Such polymers are discussed in U.S. Pat. No. 5,332,613 to Taylor et al. (Taylor) which is hereby incorporated by reference. In such polymers, A is a thermoplastic polymer block and B is an isoprene monomer unit hydrogenated to a substantially poly(ethylene-propylene) unit. An example of such a tetrablock copolymer is a styrene-poly(ethylene-propylene)-styrene-poly(ethylene-propylene) or SEPSEP elastomeric block copolymer, available from Kraton Polymers under the trade designation Kraton® G-1659.

The multiple component crimped spunbond webs and elastomeric spunbond webs suitable for forming the composite nonwoven sheets of the present invention can be prepared using spunbond methods known in the art. For example, in preparing a bicomponent crimpable spunbond web, the two polymeric components can be melted in separate extruders and forced through filters and metering pumps, then combined in a spin beam and extruded through extrusion orifices designed to produce the desired bicomponent fiber cross-section and denier-per-filament. The polymeric components can include small amounts of conventional additives such as dyes, pigments, antioxidants, UV stabilizers, spin finishes, and the like to the extent that they do not interfere with the spunbond process. Spinnerets for use in spunbond processes are well known in the art and generally have extrusion orifices arranged in one or more rows along the length of the spinneret face. The spin beam generally includes a spin pack which distributes and meters the polymers. Within the spin pack, the polymeric components flow through a pattern of openings arranged to form the desired fiber cross-section. The extrusion orifice openings may be arranged on the spinneret face in a conventional pattern (rectangular, staggered, etc.) with the spacing of the openings set to optimize productivity and filament quenching. The density of the openings is typically in the range of 500 to 8000 holes/meter width of the pack. Typical polymer throughputs per opening are in the range of 0.3 to 5.0 g/min. Spunbond filaments are generally round but can be made in a variety of other shapes (e.g. oval, tri-lobal, multi-lobal, flat, hollow, etc.). The ratio of the two polymeric components in bicomponent spunbond filaments is generally between about 10:90 and 90:10 based on volume (for example, measured as a ratio of metering pump speeds), preferably between about 30:70 and 70:30, and most preferably between about 40:60 and 60:40. The polymers spun from the extrusion orifices form a plurality of vertically oriented filaments which creates a curtain of downwardly moving filaments. As the filaments are extruded from the spinneret they are drawn and cooled with quenching gas, such as air. For example, the filaments can be passed through a pneumatic draw jet before being laid down to form a spunbond web. The jet provides the draw tension to draw the filaments near the surface of the spinneret face. Other methods for drawing the filaments such as one or more pair of draw rolls can be used. U.S. Pat. No. 5,418,045 to Pike et al. (Pike), which is hereby incorporated by reference, describes a process for making a crimped spunbond web, which includes the step of activating the crimp prior to laydown of the filaments to form the spunbond web.

In one embodiment, the crimp activating step can include heating the multiple component filaments with a flow of heated air, for example by supplying heated air to the draw jet. U.S. Provisional Application No. 60/324,855, which is hereby incorporated by reference, describes a process for making a crimped spunbond web from multiple component polyester combinations disclosed in Evans, which utilizes draw rolls prior to a forwarding jet. For certain polymer combinations, some degree of spiral crimp will develop spontaneously as the filaments exit the jet even in the absence of heating in the draw jet. Spontaneous crimp development generally occurs if one of the polymers has a glass transition temperature that is below room temperature. Examples of polymer combinations that will form spontaneous crimp include poly(ethylene terephthalate)/polypropylene and poly(ethylene terephthalate)/linear low density polyethylene. After exiting the jet, the spunbond filaments are generally deposited on a collector surface such as a laydown belt or forming screen to form a web of substantially continuous filaments. Vacuum suction can applied from below the collector surface to help pin the continuous filament web to the belt. The crimp can be activated after the filaments have been laid down to form the web. For example, a multiple component spunbond web can be heated using a number of heating sources including microwave radiation, hot air, and radiant heaters.

The multi-layer composite nonwoven sheets of the current invention are prepared by forming a layered structure comprising at least one crimped multiple component spunbond nonwoven layer and at least one elastomeric spunbond layer followed by mechanically needling the layered nonwoven structure. Mechanical needling, sometimes termed needle-punching, is achieved using methods known in the art. Generally, the mechanical needling step is performed while the layers are in a substantially relaxed condition. During mechanical needling, a plurality of needles are passed through the top layer of the composite nonwoven sheet, passed through any intermediate layers, and finally through the outer backside web of the composite sheet, after which they are withdrawn from the layered web. The layered sheet can be needled from one or both sides. Preferably, needling is carried out with the elastomeric spunbond layer facing the needles.

Needles used for mechanical needling generally have a blunt, barbed or forked configuration adapted to engage the filaments that are contacted as they penetrate an upper nonwoven layer and move a portion of the filaments into engagement with filaments in the lower layers, such as in the outer backside web. Similarly, as the needles are withdrawn from the layered composite, filaments from the lower layers are pulled by the needles and engaged with filaments in the upper layers. The various web layers become mechanically interconnected and interlocked through the entanglement of the filaments from the different layers during the mechanical needling process. When a two-layer mechanically needled composite nonwoven sheet is prepared according to the current invention, the hand of the composite sheet on the elastomeric spunbond side of the composite is more textile-like and significantly less rubber-like than the elastomeric spunbond layer alone. This improvement in hand is achieved without using hydraulic needling or thermal bonding methods.

The mechanical needling conditions are selected so as to yield a composite nonwoven sheet having good strength and surface stability while retaining elastic properties, softness, and bulk. Preferably, the mechanically needled composite sheet retains at least about 70% of the original thickness (before needling), where the original thickness is the sum of the thickness of the individual nonwoven layers used to prepare the composite nonwoven sheet. In some cases, the thickness of the needle-punched composite nonwoven sheet was observed to be greater than the original thickness (before needling), in some cases as high as 120% of the original thickness.

The multi-layer spunbond nonwoven sheets of the current invention can be prepared in a continuous process, for example by sequentially depositing the spunbond layers from different spin beams in the desired sequence onto a collecting surface followed by mechanically needling the layers in-line to form the bonded multi-layer composite sheet.

Alternately, the layered composite can be lightly pre-bonded to allow the composite web to be wound up and mechanically needled in later processing. In another embodiment, the crimped multiple component and elastomeric spunbond webs can be formed in separate processes and the layered composite formed and mechanically needled in later processing. Any pre-bonding of the individual spunbond layers or the layered spunbond composite prior to mechanical needling should be conducted using methods that do not significantly reduce the bulk of the crimped layer or significantly reduce the soft hand and elasticity of the fabric. For example, very light thermal bonding can be used. Appropriate selection of pre-bonding temperature and nip pressure can provide sufficient bonding to allow the spunbond sheets to be handled without any substantial change in hand or elastic properties after mechanical needling. This is in contrast to mechanically needled composite spunbond sheets that have not been pre-bonded. For example, a pre-bonding temperature of 105° C. and a nip pressure of 50 pounds per linear inch has been found to be useful for pre-bonding multi-layer composite nonwoven sheets which include bicomponent linear low density polyethylene/poly(ethylene terephthalate) side-by-side filaments. In contrast, a temperature of 125° C. or higher and nip pressures of 300-400 pounds per linear inch would be used for conventional thermal bonding of the same materials. When the layered web spunbond process and mechanical needling is conducted in-line, there is generally no need for pre-bonding the individual layers or the layered web prior to mechanical needling.

The basis weight of each individual spunbond layer used to form the multi-layer composite can generally be between about 17 g/m² and 70 g/m², preferably between about 25 g/m² and 50 g/m². The mechanically needled multi-layer composite nonwoven sheets of the current invention preferably have a basis weight between about 70 g/m² and 350 g/m², preferably between about 70 g/m² and 200 g/m² and a thickness between about 11 mils and 45 mils, preferably between 11 mils and 35 mils (1 mil=1/1000 inch=0.0025 cm). It should be understood that the composite is not limited in the number of spunbond layers or the number of elastomeric layers.

The stretch characteristics of the mechanically needled composite nonwoven sheets are expressed in two different ways. First, they have a cyclic recoverable stretch (as determined below) of about 10 to 70% and preferably about 20 to 40%. They also have a percent recovery of at least about 80% when stretched by 20%. These mechanically needled composite nonwoven sheets are useful for stretchable insulation and stretchable interlinings for wearing apparel and home furnishings, such as, upholstery or drapery, among other applications.

### Test Methods

In the description above and in the examples that follow, the following test methods were employed to determine various reported characteristics and properties. ASTM refers to the American Society for Testing and Materials. TAPPI refers to Technical Association of the Pulp and Paper Industry.

Melt Index is measured according to ASTM D-1238 (2.16 kg @ 190° C.), which is hereby incorporated by reference.

Effective Fiber Diameter was measured by optical microscopy and is reported as an average value in micrometers. For each spunbond sample the diameters of about 100 fibers were measured and averaged. As used herein, the “effective diameter” of a fiber with an irregular cross section is equal to the diameter of a hypothetical round fiber having the same cross sectional area.

Basis Weight is a measure of the mass per unit area of a fabric or sheet and was determined by ASTM D-3776, which is hereby incorporated by reference, and is reported in units of g/m².

Thickness of the nonwoven materials is measured by TAPPI-T411 om-97.

Stretch Properties are measured by ASTM D6614-00 Standard Test Method for Stretch Properties of Textile Fabrics—CRE Method.

Percent Recovery is expressed as [(stretched length−final sample length after removal of the stretching force)/(stretched length−initial sample length)]×100.

Cyclic Recoverable Stretch was measured by hand stretching a sample by a specified amount, holding the extended sample in the stretched condition, and then allowing the sample to relax prior to measuring the sample length after stretching. This was done by cutting 1″ wide by 6″ long (2.54 cm wide×15.2 cm long) strips such that the length of each strip was aligned with the cross-direction of the spunbond layers. The sample was held at the tip of the ends of the fabric and extended gradually by hand by 10% (i.e. to an extended length of 6.6″ (16.8 cm)), the length being measured with the aid of a ruler. The sample was held in the extended position for about 3 seconds, after which the tension was released and the sample was allowed to recover for 10 seconds and the final length measured. If the sample recovered to substantially its original length (i.e., 6.1 inches for the first time), the sample was again extended by an additional 10% of its original length using the same procedure. As long as the sample recovered to substantially its original length after being stretched, the procedure was repeated at increasing increments of 10% until an extension level was reached at which the sample failed to recover to substantially its original length after stretching. The cyclic recoverable stretch is reported as 10% less than the final value at which the sample did not recover to its original length. This process was repeated on 6 different samples and the values averaged to obtain the recoverable stretch. An Instron machine can also be used to measure recoverable stretch instead of stretching the samples by hand.

### EXAMPLE 1

This example demonstrates preparation of a three-layer mechanically needled spunbond composite nonwoven sheet according to the current invention. The outer spunbond layers were made of crimped side-by-side continuous filaments of poly(ethylene terephthalate)/linear low density polyethylene and the inner spunbond layer were made from continuous filaments of an elastomeric copolyetherester.

The crimped spunbond layers were prepared by side-by-side bicomponent spinning of a polyester component and a polyethylene component using a post-coalescent spinneret. The spinneret orifices were round, having a diameter of 0.35 mm, and were arranged on the spinneret face in 17 rows, with the distance between the outside edges of the orifices of the outermost rows being 165 mm. Each row consisted of 59 combined orifices, each combined orifice consisting of two spin orifices (for a total of 118 orifices/row) with the spacing between the outermost pairs of combined orifices in each row being 560.9 mm. The spinneret capillaries in each of the combined orifices were arranged with an included angle of 60 degrees between the capillary centerlines and a vertical travel distance of 0.22 mm. The vertical travel distance is the vertical distance between the spinneret face and the point of intersection of the axes along which the capillary centerlines lie.

The polyester component of the spunbond bicomponent filaments was poly(ethylene terephthalate) available from DuPont as Crystar® 4449 polyester having an intrinsic viscosity of 0.53 dl/g (measured according to ASTM D-2857 in hexafluoropropanol with 0.01 M sodium trifluoroacetate at 35° C.). The polyethylene component was a linear low density polyethylene (LLDPE) available from Dow as ASPUN 6811A having a reported melt index of 27 g/10 min. The polyester resin was crystallized at a temperature of 180° C. and dried at a temperature of 120° C. to a moisture content of less than 50 ppm before use. The polyester component was heated to 290° C. and the LLDPE component was heated to 250° C. in separate extruders. The polymers were extruded, filtered, and metered to the side-by-side, post-coalescent spinneret described above, which was maintained at 295° C. The transfer lines used for transporting polymer melts to the spin-pack further heated the polyester component to 290° C. and the LLDPE component to 280° C.

The polymer flow through each polyester capillary and each polyethylene capillary was adjusted to provide filaments that were 50 weight percent LLDPE and 50 weight percent polyester. The 1003 bicomponent filaments were cooled in a quenching zone 38.1 cm long with quenching air provided from two opposing quench boxes at a temperature of 12° C. and at a velocity of 1 m/sec. The filaments passed into a pneumatic draw jet spaced 20 inches (50.8 cm) below the capillary openings of the spin block where the filaments were drawn at a rate of approximately 4000 m/min. The resulting substantially continuous filaments were deposited onto a laydown belt with vacuum suction to form a spunbond web having a basis weight of 40 g/m². The filaments spontaneously developed three-dimensional crimp prior to laydown. The spunbond filaments had an effective diameter in the range of 15 to 17 micrometers. The bicomponent spunbond web was lightly pre-bonded by passing the spunbond web between an engraved oil-heated metal calender roll and a smooth oil-heated calender roll, each having a diameter of 466 mm. The engraved roll had a chrome coated non-hardened steel surface with a diamond pattern having a point size of 0.466 mm², a point depth of 0.86 mm, a point spacing of 1.2 mm, and a bond area of 14.6%. The smooth roll had a hardened steel surface. The bicomponent spunbond web was pre-bonded using an oil temperature of 105° C., a nip pressure of 50 pounds/linear inch and a line speed of 50 m/min.

The elastomeric spunbond layer was made by melt spinning an elastomeric polyester polymer. The polymer used was Hytrel® 8111, available from DuPont. The Hytrel® polymer was dried in a vertical hopper drier at a temperature of 65° C. The moisture content of polymer at the time of spinning was about 150 ppm. The polymer was heated to a temperature of 220° C. in an extruder. The polymer melt was extruded, filtered, and metered to a rectangular spin-pack consisting of several linear rows of polymer capillaries. The polymer orifices were round, having a diameter of 0.35 mm (with a length-to-diameter ratio of 4) and were arranged on the spinneret face in 21 rows, with the distance between the outside edges of the orifices of the outermost rows being 165 mm. Each row consisted of 80 orifices, with the spacing between the outermost orifices in each row being 560.9 mm. A stack of distribution plates in the spin-pack metered equal amounts of polymer to all capillaries. The spin-pack temperature was maintained at 235° C. The transfer lines that transported the polymer melt from extruder exit to the metering pumps were maintained at a temperature of 220° C. The polymer flow through each polymer capillary was set at 0.5 g/min. The 1680 filaments were cooled in a 15 inch (38.1 cm) long quenching zone with quenching air provided from two opposing quench boxes at a temperature of 12° C. and at a velocity of 1 m/sec. The filaments passed into a pneumatic draw jet spaced 25 inches below the capillary openings of the spin block where the filaments were drawn at a rate of approximately 1000 m/min. The resulting substantially continuous filaments were deposited onto a laydown belt with vacuum suction to form a spunbond web having a basis weight of 60 g/m². The spunbond filaments had an effective diameter in the range of 20 to 22 micrometers. The filaments were well quenched and laid down to form a uniform sheet. The sheet was lightly pre-bonded at a temperature of 175° C. and 50 pounds/linear inch nip pressure using the bonding apparatus described above.

A three-layer nonwoven sheet was formed by sandwiching one layer of the elastomeric copolyetherester spunbond web between two layers of the crimped poly(ethylene terephthalate)/linear low density polyethylene spunbond webs. The combined basis weight of the three layers was 140 g/m².

The layered spunbond structure was bonded on a needle punching machine using 40 gauge needles arranged in a triangular block configuration. The combined spunbond layers were passed through the machine so that about 600 punches/in² (93 punches/cm²) was obtained. The machine had the capability of needle punching from one side only, therefore, the samples where then turned over and passed through the machine again with the opposite side facing upwards so as to simulate a two-sided needle punching process. Thus, the total needle punch area density was about 1200 punches/in² (186 punches/cm²). The resulting 3-layer mechanically needled composite nonwoven sheet had a thickness of 25 mils, a very soft and cloth-like hand and good drape.

The composite sheet had a cyclic recoverable stretch of 20% in the cross-direction. Specifically, in accordance with method described above, the sample was stretched by 10%, 20% and then 30% from which the sample did not substantially recover. Therefore, the cyclic recoverable stretch was determined to be 20%.

The composite sheet also had good surface stability as evidenced by the lack of loose fibers on the surface of the sheet after undergoing 3 cycles of stretch/recovery described as follows and slightly different from the test method above:

A new strip of sample was stretched by 20% and allowed to relax to its original length. This process was repeated three times on the same sample strip (i.e. stretching to 20% and allowing it to recover). Each of the three times, the sample recovered substantially 100% of its stretch. At the end of these three cycles, the sample was visually analyzed for loose fibers on the surface.

### EXAMPLE 2

This example demonstrates preparation of a two-layer mechanically needled spunbond composite nonwoven sheet according to the current invention. One layer of the crimped poly(ethylene terephthalate)/linear low density polyethylene spunbond web and one layer of the elastomeric copolyetherester spunbond web described in Example 1 were layered to provide a two-layer laminate having a total basis weight 100 g/m². The layered structure was needle-punched using the machine the method described in Example 1.

The resulting laminate nonwoven structure had a thickness of 16 mils, a soft and cloth-like hand on both sides, good drape, and good surface stability. The laminate had a cyclic recoverable stretch of 30%.

### COMPARATIVE EXAMPLE

This example demonstrates preparation of a conventional thermally bonded crimped spunbond nonwoven sheet.

The spunbond layer made of crimped side-by-side continuous filaments of poly(ethylene terephthalate)/linear low density polyethylene was prepared by side-by-side bicomponent spinning of a polyester component and a linear low density polyethylene component using the post-coalescent spunbond process and polymeric components described in Example 1. The resulting substantially continuous filaments were deposited onto a laydown belt with vacuum suction to form a spunbond web having a basis weight of 70 g/m². The sheet was bonded in-line using the bonding rolls described in Example 1, using an oil temperature in the rolls of 128° C. and 400 pounds/linear inch nip pressure. The resulting sheet was very flat (low bulk) and had a thickness of 8 mils. All of the fibers were held in place by the thermal bond points and no loose fibers were observed on the surface. The fabric could be made to extend somewhat; however, when the sheet was extended by 10%, loose fibers were observed on the surface.

What is claimed is:

1. A stretchable multi-layer composite nonwoven sheet having first and second outer surfaces, and comprising a crimped multiple component continuous filament spunbond layer mechanically needled to a continuous filament elastomeric spunbond layer.

2. The composite nonwoven sheet according to claim 1, wherein the composite sheet has a basis weight between about 70 g/m² and 350 g/m² and a thickness between about 11 mils and 45 mils.

3. The composite nonwoven sheet according to claim 1, wherein the first outer surface of the composite sheet comprises the crimped multiple component spunbond layer and the second outer surface of the composite sheet comprises the elastomeric spunbond layer.

4. The composite nonwoven sheet according to claim 1, further comprising a second crimped multiple component continuous filament spunbond layer, wherein the first and second outer surfaces comprise the crimped multiple component spunbond layers and the elastomeric spunbond layer is sandwiched between the spunbond layers.

5. The composite nonwoven sheet according to claim 1, wherein the composite sheet has a recovery of at least 80% when stretched by 20%.

6. The composite nonwoven sheet according to claim 1, wherein the crimped multiple component spunbond layer is a bicomponent spunbond web.

7. The composite nonwoven sheet according to claim 6, wherein the bicomponent spunbond web comprises bicomponent filaments having a side-by-side or an eccentric sheath-core cross-section.

8. The composite nonwoven sheet according to claim 7, wherein the bicomponent filaments comprise a first polymeric component and a second polymeric component, and wherein the combination of first polymeric component/second polymeric component is selected from the group consisting of polypropylene/high density polyethylene, polypropylene/ethylene-vinyl acetate copolymers, poly(ethylene terephthalate)/high density polyethylene, poly(ethylene terephthalate)/linear low density polyethylene, poly(ethylene terephthalate)/poly(trimethylene terephthalate), poly(ethylene terephthalate)/poly(butylene terephthalate), and nylon 66/nylon 6.

9. The composite nonwoven sheet according to claim 8, wherein the first polymeric component comprises poly(ethylene terephthalate) and the second polymeric component comprises linear low density polyethylene.

10. The composite nonwoven sheet according to claim 7, wherein the bicomponent filaments comprise a first polymeric component comprising a partly crystalline polyester in which the chemical repeat-units of its crystalline region are in a non-extended stable conformation that does not exceed 90% of the length of the conformation of its fully extended chemical repeat-units and a second polymeric component comprising a partly crystalline polyester in which the chemical repeat-units of the crystalline region are in a conformation more closely approaching the length of the conformation of its fully extended chemical repeat-units than the first polymer.

11. The composite nonwoven sheet according to claim 10, wherein the first polymeric component is selected from the group consisting of poly(trimethylene terephthalate), poly(tetramethylene terephthalate), poly(trimethylene dinaphthalate), and poly(trimethylene bibenzoate).

12. The composite nonwoven sheet according to claim 11, wherein the second polymeric component is poly(ethylene terephthalate).

13. The composite nonwoven sheet according to claim 1, wherein the composite sheet has a cyclic recoverable stretch of at least 10%.

14. The composite nonwoven sheet according to claim 13, wherein the composite sheet has a cyclic recoverable stretch between 10% and 70%.

15. The composite nonwoven sheet according to claim 14, wherein the composite sheet has a cyclic recoverable stretch between 20% and 40%.

16. A method for forming a stretchable composite nonwoven sheet, comprising the steps of:
providing a layered nonwoven sheet comprising a crimped multiple component continuous filament spunbond layer and a continuous filament elastomeric spunbond layer; and
mechanically needling the layered nonwoven sheet.

17. The method according to claim 16, wherein the layered nonwoven sheet is formed by laying down one of the continuous filament spunbond layers as it is formed directly onto the other continuous filament spunbond layer.

18. The method according to claim 16, wherein the filaments of one or more of the spunbond layers of the layered nonwoven sheet are lightly pre-bonded by thermal bonds prior to mechanical needling, and wherein the thermal bonds are broken in the mechanical needling step.

19. An article comprising a stretchable multi-layer composite nonwoven sheet having a crimped multiple component continuous filament spunbond layer mechanically needled to a continuous filament elastomeric spunbond layer.

20. An article according to claim 19, wherein the article is a interlining for apparel.

21. An article according to claim 19, wherein the article is interlining for home furnishings.
